(19) United States
(12) Patent Application Publication
(10) Pub. No.: US 2004/0264049 A1
(43) Pub. Date: Dec. 30, 2004

(54) Magnetic bearing assembly for a data head

(76) Inventors: Richard C. Brown, Mankato, MN (US); Scott D. Ulrich, Apple Valley, MN (US); Mark R. Conner, Prior Lake, MN (US)

Correspondence Address: Seagate Technology LLC, 1280 Disc Drive, Shakopee, MN, 55379, US

(21) Appl. No.: 10/606,476

(22) Filed: Jun. 26, 2003

(51) Int. Cl. G11B 5/60

(52) U.S. Cl. 360/234

(57) ABSTRACT

A magnetic bearing assembly, which includes magnetic bearing elements on a head suspension assembly and disc. The magnetic bearing elements of the magnetic bearing assembly are operable to provide a repulsion force between the head and the disc to provide a fly-height for read or write operations. Embodiments include active fly height measurement to control fly height parameters of the head.

### FIELD OF THE INVENTION

The present invention relates generally to a data storage device, and more particularly but not by limitation to a magnetic bearing assembly to provide fly-height for a slider or head of a data storage device.

### BACKGROUND OF THE INVENTION

Data storage devices store digitally encoded information on discs. Heads read data from or write data to discs, which are supported for rotation by a spindle motor or drive. Heads are coupled to an actuator assembly to position heads relative to selective data tracks for read or write operations. Heads are coupled to an actuator arm of the actuator assembly via a flexible suspension assembly. The flexible suspension assembly typically includes a gimbal spring to allow the head to pitch and roll relative to the disc surface.

For read-write operation (e.g. proximity or near contact recording), heads fly above the disc surface at a fly-height (H_{fly}) from the disc surface. Typically, a slider body, which contains an air-bearing surface, carries transducer elements, such as read and/or write elements which is usually referred to as the head. Rotation of the disc entrains air with the disc surface, creating airflow relative to the air-bearing surface of the head, which provides, in part, a fly-height (H_{fly}) between the slider and the disc surface. As disc drive densities increase, the head fly-height has decreased (less separation between the slider and media surface) to achieve the desired read or write resolution. Current disc drive fly-heights have reached the point where the physical separation between the head and recording surface is currently smaller than a mean free path of an air molecule (at standard temperature and pressure); thus, the usefulness of classical aerodynamic models for modeling the head's air-bearing is under debate.

For contact starts and stops (CSS) heads may be supported (non-ramp load) on or contact the disc surface during non-operational periods. This physical region of the disc drive's media is commonly referred to as the “head landing zone”, or “head park area”. Contact between the slider and disc surface creates a stiction force, which must be overcome during the spin-up of the drive. Excessive stiction forces can interfere with drive operation and head take-off (achievement of designed fly-height). Current disc drive designs use laser-texturing, dither algorithms, head topology, etc. to prevent or overcome drive stiction. Nevertheless, anti-stiction techniques are constantly sought after. Embodiments of the present invention provide solutions to these and other problems, and offer other advantages over the prior art.

### SUMMARY OF THE INVENTION

The present invention relates to a magnetic bearing assembly, which includes magnetic bearing elements on a head suspension assembly and disc. The magnetic bearing elements of the magnetic bearing assembly are operable to provide a repulsion force between the head and the recording media or disc, resulting in a fly-height for read or write operations. Other features and benefits that characterize embodiments of the present invention will be apparent upon reading the following detailed description and review of the associated drawings.

### BRIEF DESCRIPTION OF THE DRAWINGS

FIG. 1 is a perspective illustration of an embodiment of a data storage device including a magnetic bearing assembly.

FIG. 2 is a schematic illustration of an embodiment of a magnetic bearing assembly for a head having a fly-height above a disc surface.

FIG. 3 is a schematic illustration of an embodiment of a head having a pitch and roll axis for a data storage device.

FIG. 4 is a schematic illustration of an embodiment of a head having bearing magnets thereon to provide a fly height for the head above the disc surface.

FIG. 5 schematically illustrates an embodiment of a bearing magnet to provide a fly height for the head above the disc surface.

FIG. 6 schematically illustrates an embodiment of a head including a magnetic bearing element for a magnetic data storage device.

FIG. 7 is a detailed illustration of a data storage device having longitudinally recorded data bits and a magnetic bearing element on the head.

FIG. 8 is a schematic illustration of an embodiment of a bearing assembly including an electromagnetic bearing.

FIG. 9 is a schematic illustration of an embodiment of a magnetic bearing assembly including a conductive element on the head.

FIG. 10 is a schematic illustration of an embodiment of an assembly for measuring fly height or head vibration.

### DETAILED DESCRIPTION OF ILLUSTRATIVE EMBODIMENTS

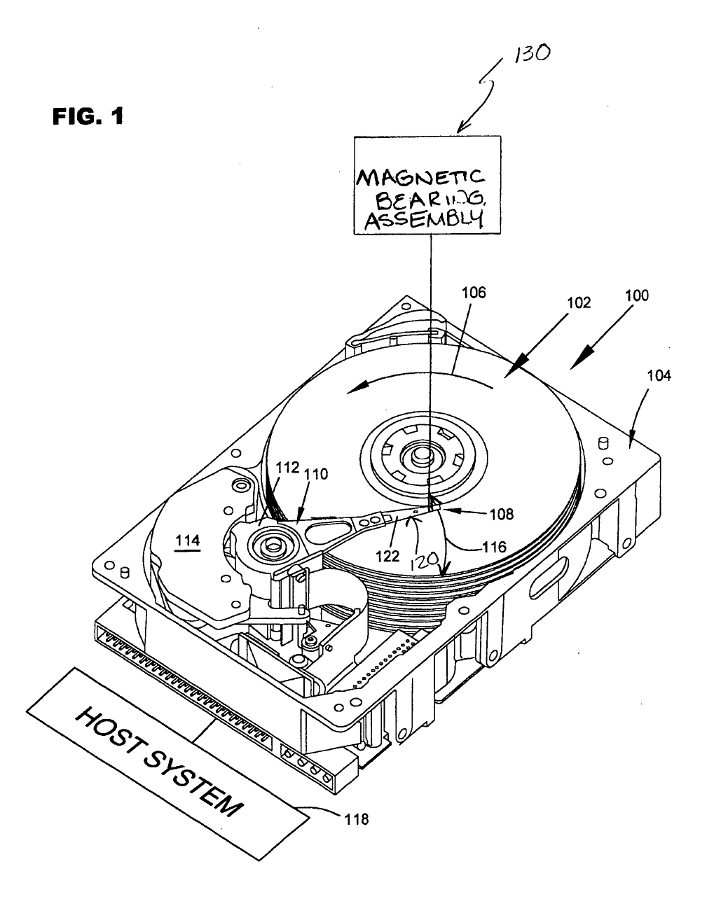

FIG. 1 is a perspective illustration of a data storage device 100 in which embodiments of the present invention are useful. Device 100 includes a plurality of discs 102 rotationally coupled to a base chassis 104 via a spindle motor (not shown) as illustrated by arrow 106. Heads (for example, magnetoresistive, magneto-optical, giant magnetoresistive or inductive heads) are coupled to an actuator assembly 110 to position the heads 108 to read data from or write data to the discs 102. In the embodiment shown, the actuator assembly 110 includes an actuator 112 which is rotated via operation of a voice coil motor (VCM) 114 to move the head 108 as illustrated by arrow 116 relative to selected tracks on the disc 102 based upon commands or signals from a host computer or system 118 (illustrated schematically).

In the embodiment shown, the head 108 is coupled to the actuator 112 via a suspension assembly 120 including a suspension arm 122 to form a head suspension assembly. In the embodiment shown, the suspension assembly or arm includes a gimbal spring (not shown) to allow the head 108 to pitch and roll relative to the disc surface to follow the topography of the disc surface. Transducer elements of the head are carried or fabricated on a slider or slider body. Known air-bearing sliders include raised bearing surfaces to provide a lifting force F_{air bearing} via pressurization of the raised bearing surfaces. In particular, rotation of the disc creates an air flow along the air-bearing surfaces of the air-bearing slider to provide the lifting force F_{air bearing} which is countered by a load force F₁ from a load beam of the suspension assembly or arm to define in part a fly-height (H_{fly}) of the slider or head above the disc surface.

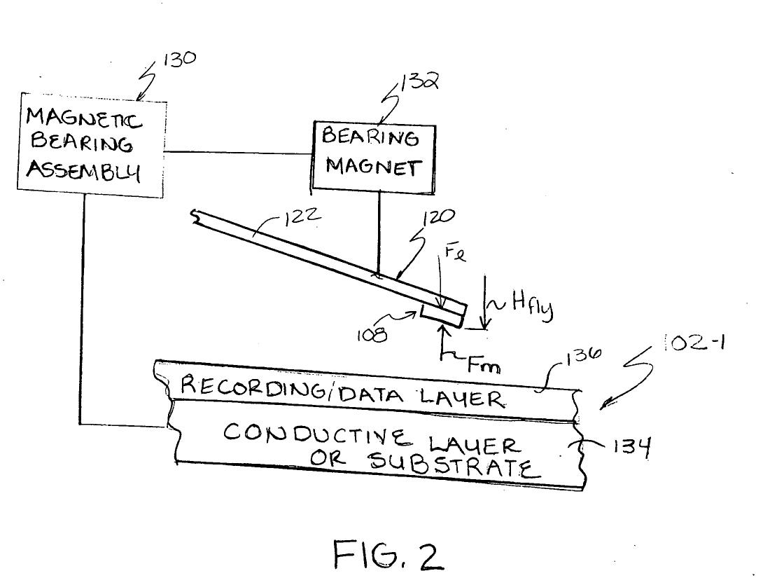

The present invention includes a magnetic bearing assembly 130 which supplies a magnetic lifting force Fm to the head 108 or slider body which in the embodiment shown in FIG. 2 is countered by load force F₁ to define, in part, the fly-height (H_{fly}) of the head or slider. In the illustrated embodiments, the magnetic bearing assembly 130 includes a bearing magnet 132 and a conductive element 134 which, form magnetic bearing elements of the magnetic bearing assembly. In the embodiment illustrated in FIG. 2, the bearing magnet 132 is coupled to the head suspension assembly and the disc 102-1 includes a conductive substrate or element 134 which cooperatively form the magnetic bearing elements of the magnetic bearing assembly 130.

In the illustrated embodiment, rotation of the disc 102-1 relative to a magnetic field B of the bearing magnet 132 induces an eddy current in the conductive substrate or element 134 as the conductive substrate or element 134 moves or crosses the flux lines of the magnetic field of magnet 132 based on Velocity×B. This, in turn, creates a magnetic field in the conductive substrate which opposes the magnetic field of the bearing magnet 132 to provide a repulsion force between the bearing magnet 132 and the conductive substrate or element 134. This force is related to a separation or distance between the bearing magnet 134 and the conductive substrate or element 134.

The bearing magnet 132 can be a permanent magnet such as a ceramic, a plastic, or a rare earth magnet, (e.g. neodymium) or an electromagnet. Known disc constructions include multiple fabrication layers including a recording layer 136 typically sputtered on an aluminum substrate. The aluminum substrate, in one embodiment, forms the conductive element and location of the induced eddy currents of the magnetic bearing assembly. Alternative substrate material embodiments could also be copper, silver, some plastics, or other nonmagnetic conductive materials. Alternatively, a conductive layer can be deposited on a disc formed of a non-conductive substrate such as glass or ceramic and thus, application of the present invention is not limited to an aluminum or conductive substrate and includes conductive layers deposited on a non conductive substrate.

As described, the disc 102 is rotated at a relatively constant velocity or revolutions per minute (RPM) for read or write operations. The magnetic bearing assembly 130 provides a relatively steady-state fly-height (H_{fly}) relative to the rotating disc. During operation, shock and vibration can be imparted to the disc drive assembly via various environmental stimuli. If the stimulus is excessive, physical contact between the head and disc surface may result, causing permanent damage to either the head or media (or both). If the stimulus is moderately excessive, the device may be unable to read the media or write. The magnetic bearing assembly 130 provides a dynamic system, which can damp vibration of the head 108 due to shock or contact (head slap) to provide a relatively stable fly-height (H_{fly}). In particular, the repulsion force varies as a function of the separation distance between the bearing magnet 132 and the conductive substrate or element 134 such that as the distance decreases the repulsion force increases or vice versa to damp vibration of the head 108 and provide a relatively stable fly-height (H_{fly}).

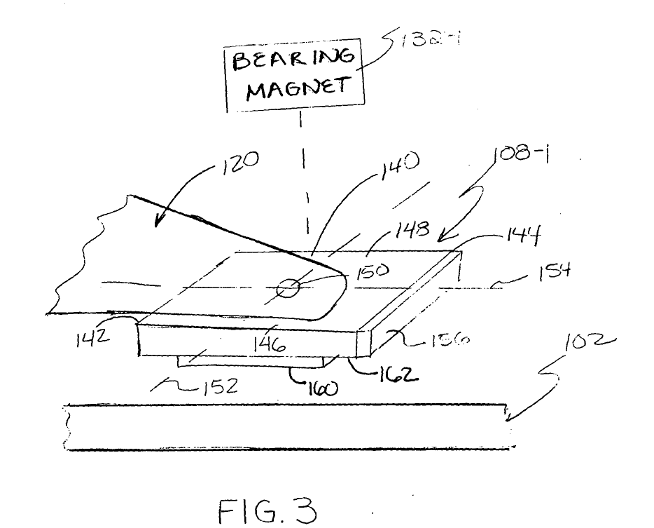

In the embodiment shown in FIG. 2, the bearing magnet 132 is coupled to the head suspension assembly to provide a magnetic field relative to the rotating disc for operation of the magnetic bearing assembly. As shown in FIG. 3, the head or head portion 108 of the head suspension assembly includes a slider or slider body 140, which as shown includes a leading edge 142, a trailing edge 144 and opposed sides 146, 148. As shown, the suspension assembly or arm supplies the load force F₁ at a load point 150 to form a pitch axis 152 about which the slider body 140 or head pitches and a roll axis 154 about which the slider body or head rolls. In the embodiment shown, a transducer or transducer portion 156 is fabricated on the trailing edge 142 of the slider body. The transducer or transducer portion 156 is fabricated via known fabrication techniques, such as thin film fabrication techniques or other fabrication techniques to form the head portion of the head suspension assembly.

In the embodiment shown in FIG. 3, the bearing magnet 132-1 is coupled to the slider or slider body 140. The bearing magnet 132-1 can be fabricated on the slider body 140 via various fabrication techniques. In particular, the bearing magnet 132-1 can be adhesively secured or attached to the slider or slider body or embedded into or formed on the slider or slider body via known deposition or masking techniques. In the particular embodiment illustrated in FIG. 3, the slider or slider body 140 includes a raised bearing surface 160 and a recessed bearing surface 162 to form an air-bearing slider. Air flows along the bearing surfaces of the slider body 140 between the leading and trailing edges 142, 144 of the slider or slider body 140 to provide lifting force F_{air bearing}. The bearing magnet 132-1 can be formed on an air bearing slider such as that illustrated in FIG. 3 to provide a lift force Fₘ or alternately can formed on a slider body which does not include functional or raised bearing surfaces or on an air bearing slider including a negative pressure cavity. Alternatively the bearing magnet 132 can be formed on the suspension portion or arm of the head suspension assembly.

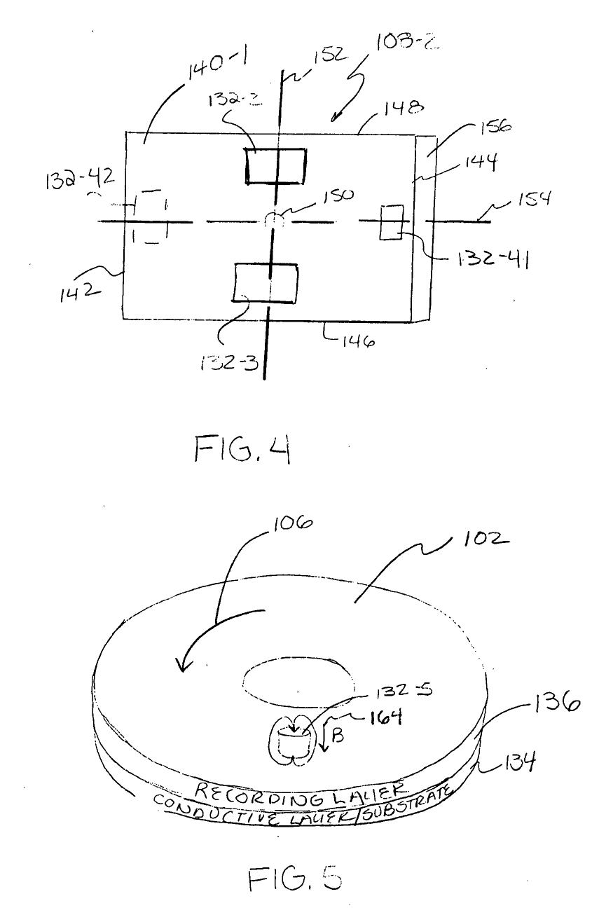

FIG. 4 illustrates a head or slider body including a plurality of bearing magnets 132-2, 132-3, 132-41 and 132-42 where like numbers are used to refer to like parts in the previous FIGS. In the illustrated embodiment shown, bearing magnets 132-2, 132-3 are located on opposed sides of the roll axis 154 to provide a dynamically stable fly height about the roll axis 154 or to enhance track following. The head or slider body typically flies at a pitch angle relative to the disc and in the illustrated embodiment, the slider body 140-1 includes a bearing magnet 132-41 spaced from the pitch axis 152 towards the trailing edge 144 of the slider 140-1 to provide a stable fly height for the trailing edge 144 of the slider body or close point (proximate to the transducer portion 156) of the head. In an alternate embodiment, the slider body 140-1 includes a bearing magnet 132-42 proximate to the leading edge 142 to form bearing magnets 132-41 and 132-42 on opposed sides of the pitch axis 152 as shown.

Although FIG. 4 illustrates bearing magnets on opposed sides of the roll axis 154 and pitch axis 152, application is not limited to the embodiment shown and alternate embodiments can include a single bearing magnet spaced from the pitch axis 152 or bearing magnets on opposed sides of the roll axis 154. As previously described, the bearing magnets can be formed as a permanent magnet or an electromagnet which can be selectively energized to control roll, pitch or fly height parameters of the slider or head.

FIG. 5 illustrates a magnetic bearing assembly which includes a bearing magnet 132-5 illustrated diagrammatically, having a magnetic field B (or pole axis) orientated generally transverse to the rotating disc 102 as illustrated by arrow 164. Rotation of the disc 102 induces an eddy current resulting in a magnetic field in a conductive layer or substrate 134, which opposes the applied magnetic field B of the bearing magnet 132-5 to provide a desired repulsion or lift force. For a magnetic recording disc, information or data is stored on a magnetic recording layer 166 as shown in FIG. 6, although application of the present invention is not limited to a magnetic recording layer. The bearing magnet 132-6 on the head suspension assembly (or slider body 140-2) is designed to provide a flux path or field strength, having a relatively low flux density to induce an eddy current in a conductive layer or substrate 134 proximate to the magnetic recording layer 166.

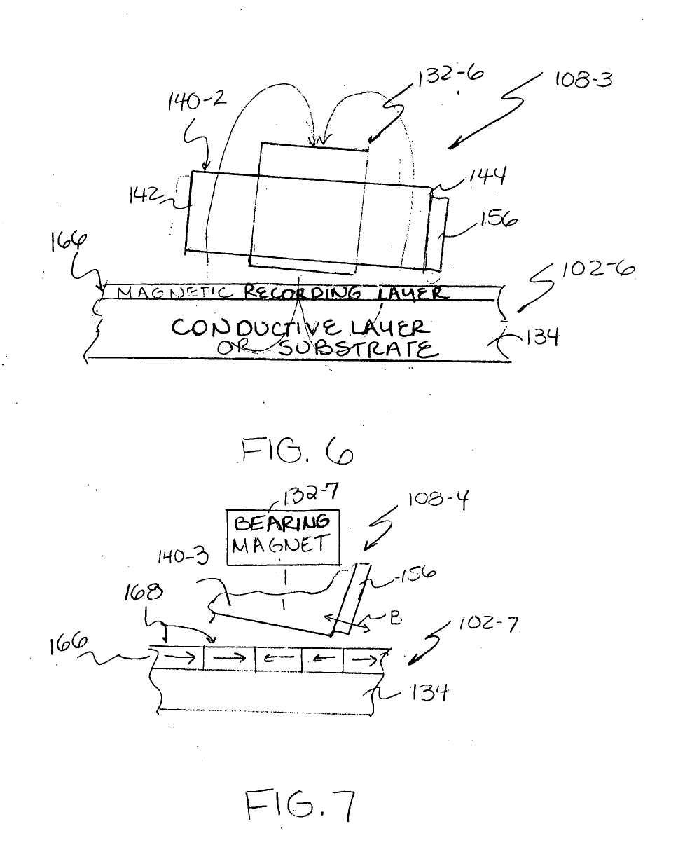

For example, FIG. 7, illustrates a head 108-4 including a transducer portion 156 having a longitudinal recording element for longitudinal recording bits 168. The field strength of the bearing magnet is relatively low relative to the coercivity of the magnetic recording layer 166 for read or write operations. Application of the magnetic bearing assembly is not limited to a longitudinal recording system and can be used for perpendicular recording or perpendicular recording heads. Again the field strength of the bearing magnet is below the coercivity of the magnetic recording layer to limit interference with the orientation or direction of the perpendicularly encoded bits, but is sufficient to induce the desired eddy currents in a conductive substrate below the magnetic recording layer.

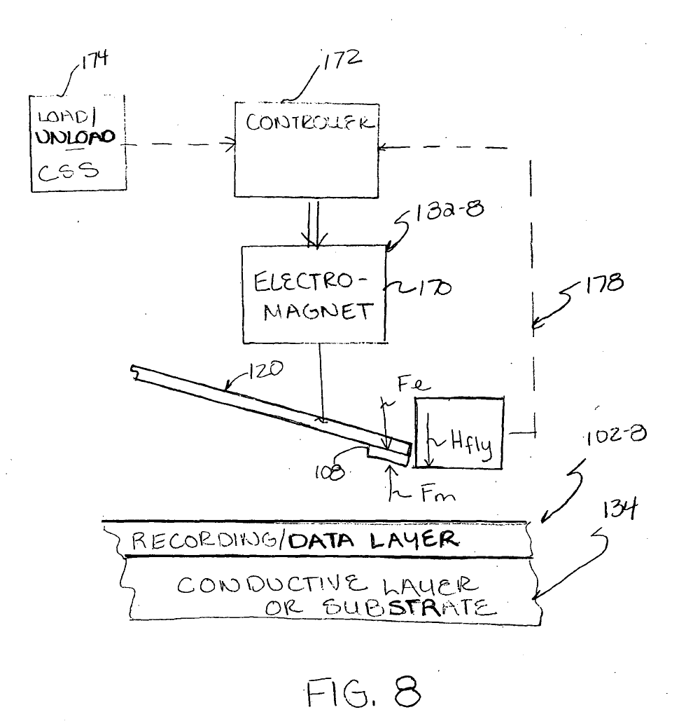

As previously described, the bearing magnet can be formed of an electro-magnet 170, which is energized by an alternating current (AC) field. In the embodiment shown in FIG. 8, the electromagnet 170 is energized via operation of a controller 172 to provide a magnetic field or flux path for the magnetic bearing assembly and hence, eddy currents in the conductive substrate even though the media or disc is static (not spinning). As shown, operation of the controller 172 can be based upon a load/unload system or CSS to provide a take off force to the head or slider body as illustrated by block 174. In particular, as previously described, for contact starts and stops (CSS) an air bearing slider may be supported on the disc surface (e.g. landing zone region) for take-off. The disc 102 is rotated to provide a take-off velocity for the air bearing slider. In a ramp load/unloaded assembly, the head or air bearing slider is supported by a ramp and is unload onto a rotating disc to provide a take-off velocity or lift. As previously described, stiction between the slider and disc surface for CSS or contact stiction at take-off can interfere with operation of the head.

As illustrated by block 174, the electromagnet 170 is energized via the controller 172 to provide a lift force prior to rotation of the disc or independent of the take off velocity of the disc to reduce head disc contact or stiction. The electro-magnet 170 is energized by an AC current to induce an eddy current or magnetic field in a conductive layer or element 134 of the disc 102-8 to provide a repulsion or lift force as previously described. In one embodiment, the magnetic field or the current supplied to the electro-magnet 170 can be varied to dynamically control or adjust fly height parameters of the head. For example, the electromagnet 170 can be energized based upon data quality measurement or fly height feedback 178. This information can be used to adjust fly height parameters to control read/write resolution and clarity.

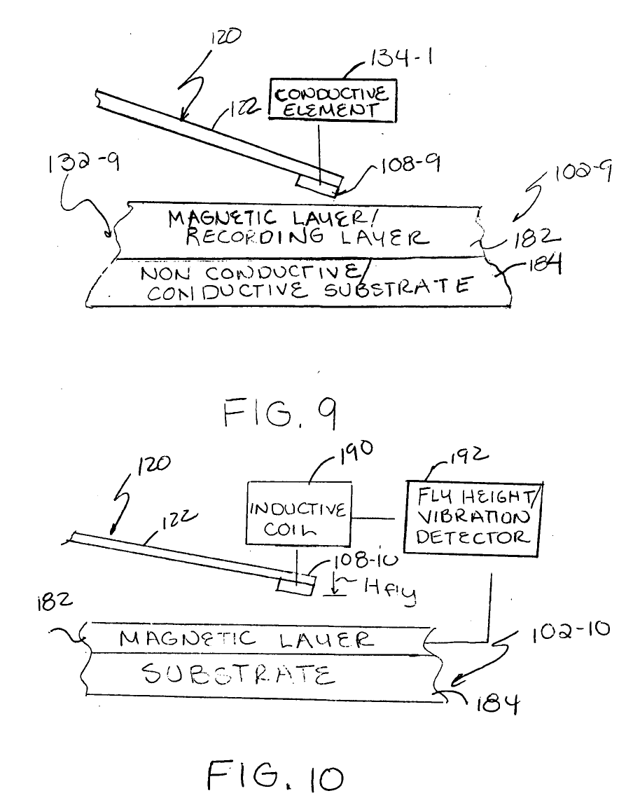

Alternatively as illustrated in FIG. 9, the conductive element 134-1 of the magnetic bearing assembly is formed on the head suspension assembly and the bearing magnet includes a magnetic layer or magnetic recording layer 182 on a conductive or non-conductive disc or substrate 184. In the embodiment shown, rotation of the disc 102-9 induces an eddy current or magnetic field in the conductive element 134-1 on the head suspension assembly which provides a repulsion force between the conductive element 134-1 on the head suspension assembly and the magnetic layer 182 on the rotating disc 102-9. For example, the magnetic layer 182 can include perpendicular recording fields, which induce an eddy current in the conductive element 134-1 via rotation of the disc 102-9 to provide a repulsion force. The magnetic layer is fabricated on a non conductive substrate or base, such as a glass substrate or base or other non-conductive material or alternatively a conductive base or substrate. The conductive element 134-1 is formed on the slider body or suspension portion of the head suspension assembly to form the conductive element 134-1 of the magnetic bearing assembly.

In an illustrated embodiment, a magnetic assembly can be used to monitor or measure head vibration or fly height. Vibration or fly height is measured by measuring an amplitude of current or voltage through or across an inductive coil or element 190 on the head or suspension portion. The current or voltage amplitude corresponds to the fly height or spacing between the head 108-10 and the disc surface or media. Fluctuations in the current or voltage provides a measurement to detect head vibration or modulation.

In particular, in one embodiment, the head (slider body) or suspension portion carries an electromagnet or coil 190 relative to the disc surface and the disc or media includes a magnetic layer or magnetic recording layer 182. Rotation of the disc provides a fly height via an air-bearing or magnetic bearing as described. Movement of the head or suspension portion in the magnetic field induces a current or voltage in the inductive coil element 190 having a magnitude related to the distance or separation between the inductive coil element 190 (or head) and the magnetic layer or disc. Detector 192 measures the voltage or current to detect head vibration or measure fly height. Feedback provided by detector 192 can be used to damp head vibration or control fly height. For example feedback from detector 192 can be used to energize electromagnet 170 to adjust fly height parameters of the head or slider body as illustrated in FIG. 7. Alternatively, feedback or vibration detection can be used with a glide head to detect disc asperities or defects and is not limited to specific embodiments shown or described.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention. In addition, although the preferred embodiment described herein is directed to a magnetic recording system, it will be appreciated by those skilled in the art that the teachings of the present invention can be applied to other data storage devices, such as optical devices without departing from the scope and spirit of the present invention.

What is claimed is:

1. A head suspension assembly comprising:
a suspension portion including a suspension arm;
a head portion coupled to the suspension arm including a slider body having a leading edge, trailing edge and opposed sides and one or more transducer elements; and
a magnetic bearing element on the slider body or suspension portion to form a magnetic bearing assembly operable to induce a repulsion force to provide a fly-height for the head portion of the head suspension assembly.

2. The head suspension assembly of claim 1 wherein the magnetic bearing element includes at least one bearing magnet.

3. The head suspension assembly of claim 2 wherein the at least one bearing magnet includes a permanent magnet.

4. The head suspension assembly of claim 2 wherein the at least one bearing magnet includes an electromagnet.

5. The head suspension assembly of claim 1 wherein the magnetic bearing element includes bearing magnets on opposed sides of either a roll axis, a pitch axis or both, of the slider body.

6. The head suspension of claim 1 wherein the magnetic bearing element includes a bearing magnet proximate to a trailing edge of the slider body spaced from a pitch axis of the slider body.

7. The head suspension assembly of claim 1 wherein the slider body includes at least one raised bearing surface and at least one recessed bearing surface.

8. The head suspension assembly of claim 1 wherein the transducer element includes a longitudinal recording element.

9. The head suspension assembly of claim 1 wherein the magnetic bearing element includes a conductive element on the slider body or suspension portion.

10. A bearing assembly for a data storage device comprising:
a head suspension assembly including a suspension portion including a suspension arm and a head portion including a slider body having a leading edge, trailing edge and opposed sides and a transducer portion including a transducer element;
a data storage disc having a recording layer; and
a magnetic bearing element on the slider body or suspension portion and a magnetic bearing element on the data storage disc and the magnetic bearing elements including a bearing magnet and a conductive element to provide a repulsion force between the head suspension assembly and the data storage disc to provide a fly height for the head portion of the head suspension above a disc surface.

11. The bearing assembly of claim 10 wherein the bearing magnet is a permanent magnet.

12. The bearing assembly of claim 10 wherein the bearing magnet is an electro-magnet.

13. The bearing assembly of claim 10 wherein the bearing magnet is formed on the slider body or suspension portion and the disc includes a conductive layer or substrate to form the conductive element.

14. The bearing assembly of claim 10 wherein the conductive element is formed on the slider body or the suspension portion and the bearing magnet is formed of a magnetic recording layer on the data storage disc.

15. The bearing assembly of claim 10 wherein the transducer element includes a longitudinal recording element.

16. The bearing assembly of claim 12 including a controller coupled to the electromagnet to selectively energize the magnetic bearing assembly.

17. The bearing assembly of claim 10 wherein the recording layer is a magnetic recording layer.

18. A method for reading or writing data relative to a disc comprising steps of:
energizing a magnetic bearing assembly to provide a lifting force to a head; and
rotating the disc to read or write data to the disc.

19. The method of claim 18 wherein the disc is rotated after energizing the magnetic bearing assembly.

20. The method of claim 18 wherein the magnetic bearing assembly includes an electromagnet and comprising the step of:
energizing the electromagnet to dynamically adjust a fly height of the head.

21. A method for reading or writing data relative to a disc comprising steps of:
rotating a disc to create a repulsion force between a magnet and a conductive element to provide a lifting force to a head; and
reading or writing data to the rotating disc.

22. The method of claim 21 and comprising the steps of:
supplying a load force to the head at a load point to define a roll axis; and
providing the repulsion force on opposed sides of the roll axis of the head.

23. A method for measuring fly height or vibration comprising the steps of:
rotating a disc; and
measuring voltage or current across an inductive coil to measure fly height or head vibration.

24. The method of claim 23 and further comprising the step of detecting asperities or defects on the disc based upon the measured voltage or current fluctuations.
